(19) United States
(12) Patent Application Publication
(10) Pub. No.: US 2024/0291226 A1
(43) Pub. Date: Aug. 29, 2024

(54) GAS CONTROL APPARATUS FOR GAS DISCHARGE STAGE

(71) Applicant: Cymer, LLC, San Diego, CA (US)

(72) Inventors: Siyu Chen, San Diego, CA (US); Spencer Ryan Williams, San Diego, CA (US)

(21) Appl. No.: 18/571,826

(22) PCT Filed: Jun. 2, 2022
(86) PCT No.: PCT/US2022/032007

§ 371 Date: Dec. 19, 2023

Related U.S. Application Data
(60) Provisional application No. 63/217,537, filed on Jul. 1, 2021.

(51) Int. Cl. H01S 3/134; G03F 7/00; G03F 7/20; H01S 3/036; H01S 3/13; H01S 3/225; H01S 3/23

(52) U.S. Cl. CPC H01S 3/134; H01S 3/036; H01S 3/1305; H01S 3/225; H01S 3/2308; H01S 3/2366; G03F 7/2004; G03F 7/70025

(57) ABSTRACT

A gas control apparatus includes a control system in communication with a gas discharge chamber. The control system includes a performance monitoring module configured to, during standard mode of operation of the gas discharge chamber and in between performance of gas recovery schemes on the gas discharge chamber that use a gas recovery setting: compare one or more performance parameters of the gas discharge chamber to respective thresholds; determine whether the gas recovery setting needs to be adjusted based on the comparison; and adjust the value for the gas recovery setting based on the determination. The control system includes a gas recovery module configured to perform the gas recovery scheme, the gas recovery module being configured to access the most recently adjusted value for the gas recovery setting from the performance monitoring module when performing the current gas recovery scheme.

### CROSS REFERENCE TO RELATED APPLICATIONS

This application claims priority to U.S. Application No. 63/217,537, filed Jul. 1, 2021, titled GAS CONTROL APPARATUS FOR GAS DISCHARGE STAGE, which is incorporated herein in its entirety by reference.

### TECHNICAL FIELD

The disclosed subject matter relates to a gas control apparatus for a gas discharge stage that includes a module that estimates a gas recovery setting during standard mode of operation.

### BACKGROUND

One kind of gas discharge light source used in photolithography is termed an excimer light source or laser. Typically, an excimer laser uses a combination of one or more noble gases, which can include argon, krypton, or xenon, and a reactive gas, which can include fluorine or chlorine. The excimer laser can create an excimer, a pseudo-molecule, under appropriate conditions of electrical simulation (energy supplied) and high pressure (of the gas mixture), the excimer only existing in an energized state. The excimer in an energized state gives rise to amplified light in the ultraviolet range. An excimer light source can use a single gas discharge chamber or a plurality of gas discharge chambers. When the excimer light source is performing, the excimer light source produces a deep ultraviolet (DUV) light beam. DUV light can include wavelengths from, for example, about 100 nanometers (nm) to about 400 nm.

The DUV light beam can be directed to a photolithography exposure apparatus or scanner, which is a machine that applies a desired pattern onto a target portion of a substrate (such as a silicon wafer). The DUV light beam interacts with a projection optical system, which projects the DUV light beam through a mask onto the photoresist of the wafer. In this way, one or more layers of chip design is patterned onto the photoresist and the wafer is subsequently etched and cleaned.

### SUMMARY

In some general aspects, a gas control apparatus is associated with a gas discharge chamber within a light source. The gas control apparatus includes: a monitoring system configured to estimate one or more performance parameters of the gas discharge chamber; and a control system in communication with the monitoring system and the gas discharge chamber. The control system is configured to, during standard mode of operation of the gas discharge chamber and in between performance of gas recovery schemes on the gas discharge chamber that use a gas recovery setting: compare the estimated one or more performance parameters to respective thresholds; determine whether the gas recovery setting needs to be adjusted based on the comparison; and adjust the value for the gas recovery setting based on the determination.

Implementations can include one or more of the following features. For example, the gas control apparatus can further include a gas supply system configured to inject and/or remove one or more gas components of a gas mixture within the gas discharge chamber in accordance with at least one gas recovery setting and under control of the control system during the gas recovery scheme.

The control system can be configured to, during standard operation of the gas discharge chamber and in between performing gas recovery schemes on the gas discharge chamber that use the gas recovery setting, save the adjusted value for the gas recovery setting. The control system can access the most recent adjusted value for the gas recovery setting when performing the next gas recovery scheme. The gas recovery setting can be an extreme operating value of a gas characteristic. The gas recovery setting can be an extreme value of a pressure in the gas discharge chamber.

The monitoring system being configured to estimate one or more performance parameters of the gas discharge chamber can include the monitoring system estimating one or more of: an energy of a light beam output from the gas discharge chamber, an energy variation predictor of an energy source actuator of the gas discharge chamber, a spectral feature of a light beam output from the gas discharge chamber, an energy supplied to the gas discharge chamber by way of the energy source actuator, and an arcing risk sensitivity.

The control system being configured to adjust the value for the gas recovery setting based on the determination can include adjusting the value for the gas recovery setting by an incremental amount and between a maximum and a minimum extreme value. The control system being configured to compare the estimated one or more performance parameters to respective thresholds can include determining whether each performance parameter exceeds its respective threshold. A performance parameter can be at an acceptable value if it exceeds its respective threshold.

During standard operation of the gas discharge chamber and in between performing gas recovery schemes on the gas discharge chamber that use the gas recovery setting, the monitoring system can estimate the one or more performance parameters of the gas discharge chamber at periodic intervals. The control system can be configured to, for each time the one or more performance parameters are estimated by the monitoring system, compare the estimated one or more performance parameters are to respective thresholds, determine whether to adjust the gas recovery setting based on the comparison, and adjust the value for the gas recovery setting based on the determination.

The control system can be configured to halt adjusting the value for the gas recovery setting when a command is received indicating a start of the gas recovery scheme. The control system can be configured to perform a gas recovery scheme after directing a gas refill on the gas discharge chamber and after the gas refill on the gas discharge chamber is completed.

The monitoring system can be configured to monitor at least one gas discharge chamber of a two-stage light source that includes a master oscillator gas discharge chamber and a power amplifier gas discharge chamber. The control system can be in communication with the master oscillator gas discharge chamber and the power amplifier gas discharge chamber, and the gas recovery setting can relate to the power amplifier gas discharge chamber. The gas discharge chamber can be implemented in a gas discharge stage of the light source, the gas discharge stage producing an amplified light beam from a population inversion occurring in a gas mixture within the gas discharge chamber when energy is provided to the gas mixture.

The monitoring system being configured to estimate the one or more performance parameters of the gas discharge chamber can include the monitoring system measuring one or more aspects relating to performance of the gas discharge chamber and analyzing the measured aspects.

In other general aspects, a method is configured for controlling a gas mixture of a gas discharge chamber within a gas discharge light source. The method includes, during standard operation of the gas discharge chamber and in between performing gas recovery schemes on the gas discharge chamber that use a gas recovery setting: estimating one or more performance parameters of the gas discharge chamber; comparing the estimated one or more performance parameters to respective thresholds; determining whether the gas recovery setting needs to be adjusted based on the comparison; and adjusting the value for the gas recovery setting based on the determination.

Implementations can include one or more of the following features. For example, the method can further include, during standard operation of the gas discharge chamber and in between performing gas recovery schemes on the gas discharge chamber that use a gas recovery setting, saving the adjusted value for the gas recovery setting. The method can further include providing the most recent adjusted value for the gas recovery setting to the next gas recovery scheme.

The gas recovery setting can be an extreme operating value of a gas characteristic. The gas recovery setting can be an extreme value of a pressure in the gas discharge chamber.

The one or more performance parameters of the gas discharge chamber can be estimated by estimating one or more of: an energy of a light beam output from the gas discharge chamber, an energy variation predictor of an energy source actuator of the gas discharge chamber, a spectral feature of a light beam output from the gas discharge chamber, an energy supplied to the gas discharge chamber by way of the energy source actuator, and an arcing risk sensitivity.

The gas recovery setting can be determined as needing to be adjusted based on the comparison by determining that the gas recovery setting does not need to be adjusted if all of the estimated one or more performance parameters exceed their respective thresholds. A performance parameter can exceed its threshold if it is greater than its threshold. The gas recovery setting can be determined as needing to be adjusted based on the comparison by determining that the gas recovery setting needs to be adjusted if one of the estimated one or more performance parameters does not exceed its respective threshold and the remaining of the estimated one or more performance parameters exceed their respective thresholds. The gas recovery setting can be determined as needing to be adjusted based on the comparison by determining that the gas recovery setting does not need to be adjusted if all of the estimated one or more performance parameters do not exceed their respective thresholds.

The value for the gas recovery setting can be adjusted based on the determination by adjusting the value for the gas recovery setting by an incremental amount and between a maximum and a minimum extreme value.

The estimated one or more performance parameters can be compared to respective thresholds by determining whether each performance parameter exceeds its respective threshold, wherein a performance parameter is at an acceptable value if it exceeds its respective threshold.

During standard operation of the gas discharge chamber and in between performing gas recovery schemes on the gas discharge chamber that use the gas recovery setting, the one or more performance parameters of the gas discharge chamber can be estimated at periodic intervals. The method can further include, each time the one or more performance parameters are estimated, then the estimated one or more performance parameters are compared to respective thresholds, whether to adjust the gas recovery setting can be determined based on the comparison, and the value for the gas recovery setting can be adjusted based on the determination.

The method can also include halting adjusting the value for the gas recovery setting when a command is received indicating a start of the gas recovery scheme. The method can further include performing a gas recovery scheme on the gas discharge chamber after a gas refill on the gas discharge chamber is performed.

The one or more performance parameters of the gas discharge chamber can be estimated by measuring one or more aspects relating to performance of the gas discharge chamber and analyzing the measured aspects.

In other general aspects, a gas control apparatus is associated with a gas discharge chamber, the gas control apparatus including a control system in communication with the gas discharge chamber. The control system includes a performance monitoring module and a gas recovery module. The performance monitoring module is configured to, during standard mode of operation of the gas discharge chamber and in between performance of gas recovery schemes on the gas discharge chamber that use a gas recovery setting: compare one or more performance parameters of the gas discharge chamber to respective thresholds; determine whether the gas recovery setting needs to be adjusted based on the comparison; and adjust the value for the gas recovery setting based on the determination. The gas recovery module is configured to perform the gas recovery scheme. The gas recovery module is configured to access the most recently adjusted value for the gas recovery setting from the performance monitoring module when performing the current gas recovery scheme.

### DESCRIPTION OF DRAWINGS

FIG. 1 is a block diagram of a gas control apparatus associated with a gas discharge chamber of a light source that supplies an amplified light beam to an output apparatus;

FIG. 2A is a graph of a performance parameter, an energy variation predictor dE/dV, versus a pressure in the gas discharge chamber;

FIG. 2B is a graph of a performance parameter, an energy (E150) supplied to the gas discharge chamber when performing a gas recovery scheme, versus the pressure in the gas discharge chamber;

FIG. 3 is a block diagram of an implementation of the output apparatus of FIG. 1, in which the output apparatus is a photolithography exposure apparatus;

FIG. 4 is a block diagram of an implementation of the gas control apparatus of FIG. 1, in which an implementation of the gas supply system is shown, the gas supply system being in fluid communication with the gas discharge chamber;

FIG. 5 is a block diagram of an implementation of the gas control apparatus of FIG. 1, in which a dual-stage light source is shown;

FIG. 6 is a block diagram of an implementation of a monitoring system of the gas control apparatus of FIG. 1;

FIG. 7 is a block diagram of an implementation of a control system of the gas control apparatus of FIG. 1;

FIG. 8 is a flow chart of a procedure that, in some implementations, is performed by the gas control apparatus of FIG. 1;

FIG. 9 is a block diagram showing, in some implementations, details relating to steps 824 and 825 of the procedure of FIG. 8; and

FIG. 10 shows a set of graphs for the implementation discussed with reference to FIG. 9, in which a first performance parameter is E150, a second performance parameter is dE/dV, and a gas recovery setting is minChamberPres, in which graph 1036 shows E150 versus time during three distinct standard operations of the gas discharge chamber, graph 1037 shows dE/dV versus time during the same distinct standard operations, graph 1038 shows the pressure CP within the gas discharge chamber during the same distinct standard operations, and graph 1039 shows the gas recovery setting minChamberPres for the gas discharge chamber during the same distinct standard operations.

### DESCRIPTION

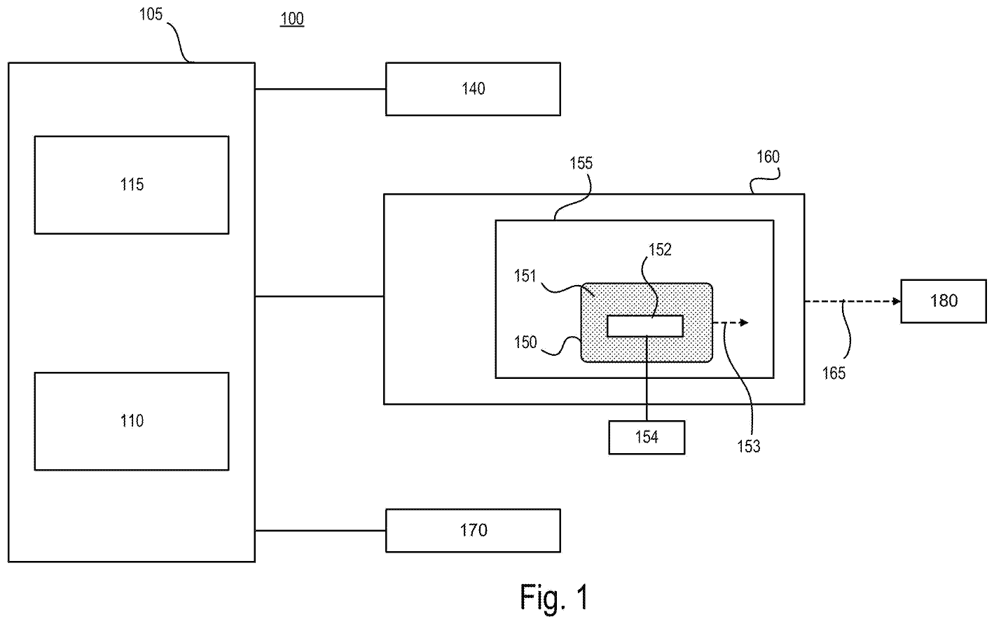

Referring to FIG. 1, a gas control apparatus 100 is associated with a gas discharge chamber 150 of a light source 160. The light source 160 is configured as part of an optical system (including optical feedback not shown in FIG. 1) that supplies an amplified light beam 165 (produced at least in part from the output of the gas discharge chamber 150) to an output apparatus 180. The output apparatus 180 can be, for example, a photolithography exposure apparatus that patterns microelectronic features on a substrate such as a wafer.

The gas control apparatus 100 includes a monitoring system 140, a gas supply system 170, and a control system 105. The control system 105 includes a gas recovery module 110 configured to perform a gas recovery scheme on the gas discharge chamber 150. The gas recovery scheme is performed on the gas discharge chamber 150 after the control system 105 directs the gas supply system 170 to perform and complete a gas maintenance scheme such as a gas refill on the gas discharge chamber 150 and the gas recovery scheme is typically performed after the gas refill or other gas maintenance scheme is actually performed and completed. In a gas refill, all of a gas mixture 151 within the gas discharge chamber 150 is replaced by, for example, emptying the gas discharge chamber (for example, by bleeding old gas mixture 151 out to a gas dump) and then refilling the gas discharge chamber 150 with a fresh gas mixture 151. The gas refill can be performed with the goal of obtaining a specific pressure and concentration of a particular material (such as fluorine) in the gas discharge chamber 150. In other gas maintenance schemes such as a scheme in which less than 100% of the gas mixture 151 is replaced, some of the gas mixture 151 within the gas discharge chamber 150 is emptied or bled before a fresh gas mixture 151 is injected into the gas discharge chamber 150.

The gas recovery scheme is performed to optimize gas pressure within the gas discharge chamber 150 in order to recover the standard operating conditions of the gas discharge chamber 150 and thus enable standard mode of operation of the gas discharge chamber 150. During the standard mode of operation of the gas discharge chamber 150, the light beam 165 is produced in accordance with requirements of output apparatus 180. In various implementations, the light beam 165 can be produced in accordance with instructions from the output apparatus 180. The gas recovery scheme can include consideration of pressure and other properties associated with another gas discharge chamber within the light source 160. For example, the gas discharge chamber 150 can be associated with a gas discharge stage 155 of the light source 160 and the light source 160 can include a second gas discharge stage with its own gas discharge chamber (such a dual-stage light source is described with reference to FIG. 5).

During one specific implementation of a gas recovery scheme, the gas recovery module 110 instructs the gas supply system 170 to supply more fresh gas mixture 151 to thereby charge or increase the pressure within the gas discharge chamber 150 to a maximum pressure setting. The gas recovery module 110 instructs an energy source actuator 154 to supply energy to an energy source 152 of the gas discharge chamber 150 to thereby produce an amplified light beam 153 from the gas discharge chamber 150. The amplified light beam 153 can correspond to the amplified light beam 165 or it can be a pre-cursor light beam from which the amplified light beam 165 is produced. Then, the gas recovery module 110 analyzes the performance of the light source 160 against a set of performance thresholds that are specific to the gas recovery scheme. The gas recovery module 110 can perform this analysis by accessing performance parameters that are tracked or monitored by the monitoring system 140. For example, performance parameters that can be monitored include an energy (E150) supplied to the gas discharge chamber 150, a high voltage setting, or an energy variation predictor (dE/dV) of the energy source actuator 154. The energy variation predictor is a value that can be used to predict the variation in energy E150 supplied to the gas discharge chamber 150 with a change in the input (which can be a voltage). Thus, the energy variation predictor dE/dV indicates how much voltage input needs to change to get a certain change in energy E150 of the gas discharge chamber 150. Thus, the energy variation predictor dE/dV is an indicator of the efficiency of the energy source actuator 154. Other performance parameters that can be tracked or monitored by the monitoring system 140 include an energy of the light beam 153 output from the gas discharge chamber 150 (or the light beam 165), a spectral feature of the light beam 153 output from the gas discharge chamber 150, or a risk sensitivity to arcing within the gas discharge chamber 150.

If the gas recovery module 110 determines that the light source 160 is not performing within the performance thresholds that are specific to the gas recovery scheme, then the gas recovery module 110 can instruct the gas supply system 170 to iteratively bleed the gas mixture 151 from the gas discharge chamber 150 (or all of the gas discharge chambers within the light source 160) until one or more conditions are met. One condition that can be met relates to a gas recovery setting. For example, one gas recovery setting can correspond to an extreme operating value of a gas characteristic such as a minimum acceptable pressure within the gas discharge chamber 150 (or within one or more of the gas discharge chambers within the light source 160). This gas recovery setting is referred to as minChamberPres. The recovery module 110 can instruct the gas supply system 170 to iteratively bleed the gas mixture 151 from the gas discharge chamber 150 until the pressure is bled to its minimum limit minChamberPres.

In prior gas control apparatuses, the gas recovery setting (such as the minChamberPres) is fixed. However, for different light sources 160 or even the same light source 160 at different ages, the performance of the light source 160 can vary, which means that the settings can vary as well. In such prior situations, the gas recovery scheme performed by the gas recovery module 110 can operate using inaccurate settings, and the result is that the light source 160 can suffer in performance after the gas recovery scheme is performed.

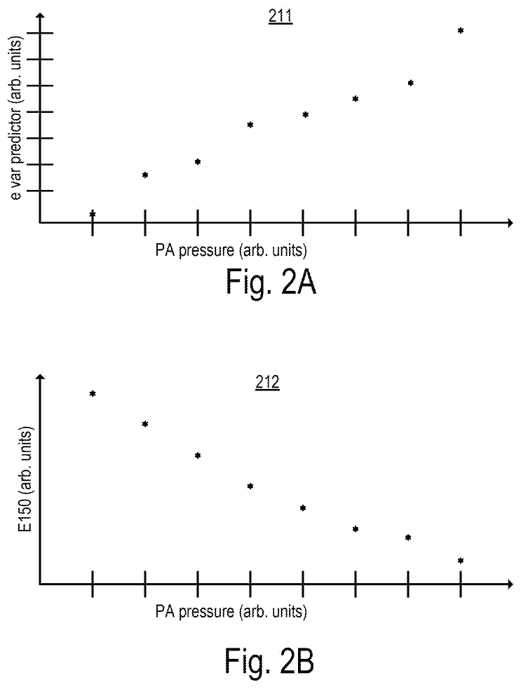

For example, and with reference to FIG. 2A, in prior gas control apparatuses, the gas recovery module 110 may not consider or track the performance parameter referred to as the energy variation predictor dE/dV (discussed above) when performing the gas recovery scheme. In general, the higher the energy variation predictor, the better the efficiency of operation of the gas discharge chamber 150. In the graph 211 of FIG. 2A, the energy variation predictor dE/dV drops as the pressure in the gas discharge chamber 150 is reduced. On the other hand, and with reference to graph 212 of FIG. 2B, the gas recovery module 110 does consider and track the performance parameter energy (E150) supplied to the gas discharge chamber 150 when performing the gas recovery scheme. For example, the gas recovery module 110 compares the energy E150 to a threshold during the gas recovery scheme, and if the energy E150 is not within its threshold, then the gas recovery module 110 bleeds the pressure in the gas discharge chamber 150. This is because the performance parameter energy E150 increases as the pressure in the gas discharge chamber 150 is reduced, as shown in FIG. 2B. Accordingly, when the gas recovery module 110 instructs the gas supply system 170 to iteratively bleed the gas mixture 151 from the gas discharge chamber 150 (to improve the energy E150), it is possible or likely for the energy variation predictor dE/dV to drop to an unacceptable value (a value that is not within its threshold), thus leading to inefficient operation of the gas discharge stage 155.

Referring again to FIG. 1, the gas control apparatus 100 includes a performance monitoring module 115 configured to continually analyze one or more performance parameters (such as the energy variation predictor dE/dV and the energy E150) during standard mode of operation of the gas discharge chamber 150. The standard mode of operation of the gas discharge chamber 150 begins after the gas recovery scheme is completed. The performance monitoring module 115 can continually update the gas recovery setting (such as the minChamberPres) based on this analysis and store the updated gas recovery setting within the control system 105. In this way, the next time the gas recovery module 110 performs the gas recovery scheme, the value of the gas recovery setting stored within the control system 105 has already been adjusted to account for changes in performance of the light source 160 that can show up as changes in the energy variation predictor dE/dV. The gas recovery module 110 uses the most recent version of the gas recovery setting when performing the gas recovery scheme. In this way, the gas recovery scheme can be performed while maintaining efficient operation and performance of the gas discharge stage 155. Moreover, the performance monitoring module 115 performs the update to the gas recovery setting without requiring the gas recovery setting to be manually adjusted. Manual adjustment to any setting used by the gas recovery module 110 can reduce the amount of time the light source 160 is available for use to produce the light beam 165, and thus can reduce the production efficiency of the output apparatus 180.

Next, the monitoring system 140, the light source 160, the gas supply system 170, and output apparatus 180 are described prior to discussing the structure and operation of the gas control apparatus 100.

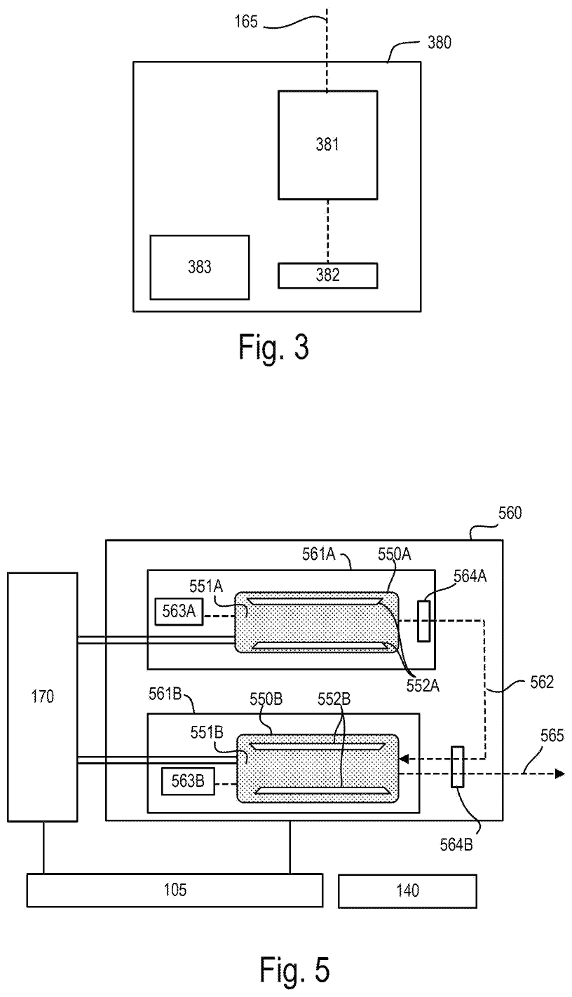

Referring to FIG. 3, in some implementations, the output apparatus 180 is a photolithography exposure apparatus 380. The exposure apparatus 380 includes an optical arrangement that includes an illuminator system 381 having, for example, one or more condenser lenses, a mask, and an objective arrangement through which the light beam 165 is directed on its way to a substrate (wafer) 382. The mask is movable along one or more directions, such as along an axis of the light beam 165 or in a plane that is perpendicular to the axis of the light beam 165. The objective arrangement includes, for example, a projection lens, and enables the image to transfer from the mask to a photoresist on the wafer 382. The illuminator system 381 adjusts the range of angles for the light beam 165 impinging on the mask. The exposure apparatus 380 can include, among other features, a lithography controller 383 that controls, among other things, how layers are printed on the wafer 382. The lithography controller 383 can be in communication with the control system 105.

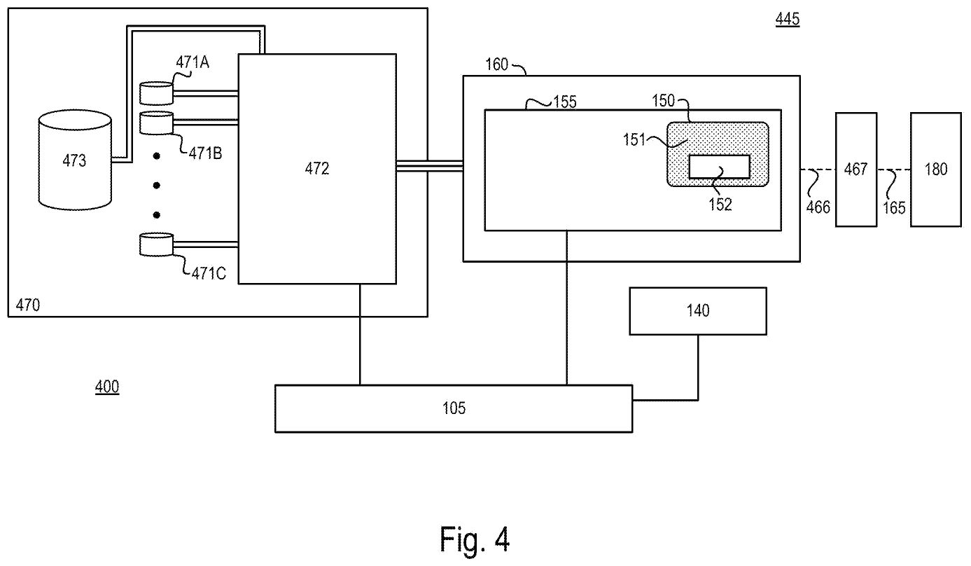

Referring to FIG. 4, in some implementations, an implementation 470 of the gas supply system 170 is shown. The gas supply system 470 is in fluid communication with the gas discharge chamber 150. The light source 160 is configured as a part of an optical system 445 that supplies the amplified light beam 165 to the output apparatus 180 (such as a photolithography exposure apparatus that patterns microelectronic features on a wafer). The optical system 445 can also include a beam preparation system 467 that receives an amplified light beam 466 output from the light source 160, modifies the light beam 466 to form the amplified light beam 165, which is then outputted for use by the output apparatus 180.

In some implementations, as discussed below with reference to FIG. 5, the light source 160 is a multi-stage system having a plurality of gas discharge stages, each including a gas discharge stage 155 that includes the gas discharge chamber 150 as well as other components (such as optical elements) that interact with the light beam 153 produced by the gas discharge chamber 150. The gas control apparatus 400 (FIG. 4) can be configured to interact with each gas discharge chamber 150 within the multi-chamber system.

Focusing on the gas discharge stage 155, the energy source 152 provides a source of pulsed energy to the gain medium within the gas mixture 151 of the gas discharge chamber 150. If the light source 160 is a multi-stage system, then the ingredients of the gas mixtures 151 in each of the other chambers of the light source 160 can be identical. Moreover, for example, in a multi-stage system, the concentrations of the various ingredients in each of the gas mixtures 151 of each of the chambers can be different.

The gas mixture 151 used in the gas discharge chamber 150 can be a combination of gases that are suitable for producing the light beam 153 (and therefore the light beam 165) at the required wavelength, bandwidth, and energy for use by the output apparatus 180. Thus, as discussed above, the gas mixture 151 can include, for example, argon fluoride (ArF), which emits at a wavelength of approximately 193 nm, or krypton fluoride (KrF), which emits at a wavelength of approximately 248 nm.

The gas supply system 470 includes one or more sources of a gas 471A, 471B, 471C; conduits for supplying the gas to the gas discharge chamber 150; and a valve system 472 that includes one or more fluid control valves between the gas sources 471A, 471B, 471C and the gas discharge chamber 150. The sources of gas 471A, 471B, 471C can supply the gas to multiple gas discharge chambers, for example, such as when a light source 160 includes multiple stages that each include a gas discharge chamber, as discussed with reference to FIG. 5. The gas sources 471A, 471B, 471C can be, for example, sealed gas bottles and/or canisters. The gas mixture 151, as an example, can contain a halogen such as fluorine, along with other gases including argon, neon, and possibly others in different partial pressures that sum to a total pressure P. Further, one or more gas sources 471A. 471B, 471C are connected to the gas discharge chamber 150 through a set of fluid control valves within the valve system 472. With this system, gas can be injected into the gas discharge chamber 150 with specific relative amounts of components of the gas mixture 151. For example, if the gain medium in the gas discharge chamber 150 is argon fluoride (ArF), then one of the gas sources 471A can contain a mixture of gases including the halogen fluorine, the noble gas argon, and one or more other rare gases such as buffer gases including inert gases like neon. The described mixture can be referred to as a tri-mix. In this example, the gas source 471B can contain a mixture of gases including argon and one or more other gases except any of fluorine. The described mixture can be referred to as a bi-mix. Although only three gas sources are shown 471A, 471B, 471C, the gas supply system 470 can have fewer than three or greater than three gas sources.

The control system 105 can communicate with the valve system 472 using one or more signals to cause the valve system 472 to transfer gases from one or more specific gas sources 471A, 471B, 471C into the gas discharge chamber 150 in a gas refill. In addition to, or alternatively, the control system 105 can communicate with the valve system 472 using one or more signals to cause the valve system 472 to bleed gas from the gas discharge chamber 150 when required, and such bled gas can be vented to a gas dump 473. Additionally, the control system 105 can include a refill status module that monitors the status of one or more fluid control valves within the valve system 472 in order to determine whether a refill is being performed on the gas discharge chamber 150.

When the gas discharge light source 160 is operating, the fluorine of the argon fluoride molecule, providing the gain medium for light amplification within the gas discharge chamber 150 is used and, over time, the efficiency of the gas discharge light source 160 is reduced. Therefore, the energy of the amplified light beam 165 is reduced as the gas discharge chamber 150 is used.

When a refill is performed on the gas discharge chamber 150, all of the gas in the gas discharge chamber 150 is replaced by, as an example, emptying the gas discharge chamber 150 by bleeding the gas mixture 151 to the gas dump 473, then refilling the gas discharge chamber 150 with a fresh or new gas mixture. A goal of the refill is to obtain a specific pressure and concentration of fluorine in the gas discharge chamber 150.

A plurality of gas sources 471A, 471B, 471C are necessary because the fluorine gas source 471A is at a particular partial pressure that is typically higher than that desired for operation of the gas discharge chamber 150. To add fluorine to the gas discharge chamber 150 at a desired lower partial pressure, the gas in the gas source 471A can be diluted, and the non-halogen containing gas in the gas source 471B can be used for this purpose.

Although it is not shown, the fluid control valves of the valve system 472 can include a plurality of valves assigned to the gas discharge chamber 150. For example, the valve system 472 can include an injection valve that allows gas to pass into and out of the gas discharge chamber 150 at a first rate, and a chamber fill valve that allows gas to pass into and out of the gas discharge chamber 150 at a second rate that is different from the first rate.

As mentioned above, in some implementations, the light source 160 is a multi-stage system. In the implementation shown in FIG. 5, the light source 160 is a two-stage light source 560. The light source 560 includes a master oscillator 561A as its first stage and a power amplifier 561B as its second stage. The master oscillator 561A includes a master oscillator gas discharge chamber 550A and the power amplifier 561B includes a power amplifier gas discharge chamber 550B. The master oscillator gas discharge chamber 550A includes as the energy source 552A two elongated electrodes that provide a source of pulsed energy to a gas mixture 551A within the chamber 550A. The power amplifier gas discharge chamber 550B includes as the energy source 552B two elongated electrodes that provide a source of pulsed energy to a gas mixture 551B within the chamber 550B.

The master oscillator 561A provides a pulsed amplified light beam (called a seed light beam) 562 to the power amplifier 561B. The master oscillator gas discharge chamber 550A houses the gas mixture 551A that includes a gain medium in which amplification occurs and the master oscillator 561A includes an optical feedback mechanism such as an optical resonator. The optical resonator is formed between a spectral optical system 563A on one side of the master oscillator gas discharge chamber 550A and an output coupler 564A on a second side of the master oscillator gas discharge chamber 550A. The power amplifier gas discharge chamber 550B houses the gas mixture 551B that includes a gain medium in which amplification occurs when seeded with the seed light beam 562 from the master oscillator 561A. If the power amplifier 561B is designed as a regenerative ring resonator then it is described as a power ring amplifier, and in this case, enough optical feedback can be provided from the ring design. The power amplifier 561B can also include a beam return (such as a reflector) 563B that returns (via reflection, for example) the light beam back into the power amplifier gas discharge chamber 552B to form a circulating and looped path (in which the input into the ring amplifier intersects the output out of the ring amplifier) and also an output coupler 564B for inputting the seed light beam 562 and outputting an amplified light beam 565. The light beam 153 can correspond to the seed light beam 562 or the amplified light beam 565.

The gas mixture (for example, gas mixture 551A, 551B) used in the respective discharge chamber 550A, 550B can be a combination of suitable gases for producing the amplified light beam around the required wavelengths, bandwidth, and energy. For example, as discussed above, the gas mixture 551A, 551B can include argon fluoride (ArF), which emits light at a wavelength of about 193 nm, or krypton fluoride (KrF), which emits light at a wavelength of about 248 nm.

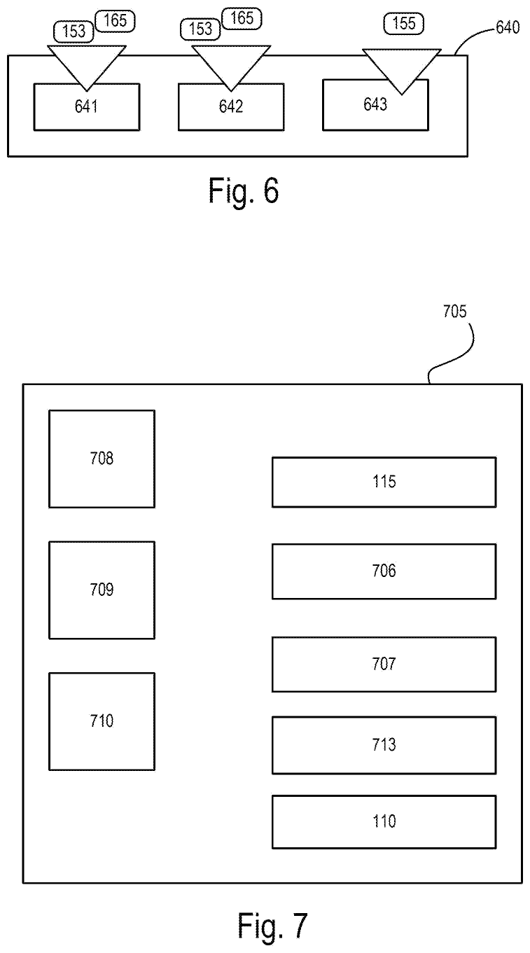

Referring to FIG. 6, an implementation 640 of the monitoring system 140 is shown. The monitoring system 640 includes a set of sub-units 641, 642, 643 that are tailored for observing or measuring aspects of the light source 160. For example, the monitoring system 640 includes a line center analysis sub-unit 641; a spectral feature sub-unit 642; and an actuator sub-unit 643. The line center analysis sub-unit 641 observes, measures, or estimates an energy of one or more amplified light beams such as light beams 153, 165 produced by or within the gas discharge stage 155. For example, the line center analysis sub-unit 641 can include an optical power meter in the path of the light beam 153, 165. Additionally, the line center analysis sub-unit 641 can include a wavelength meter configured to measure the wavelength of the light beam 153, 165. For example, such wavelength meter can sample a portion of the output of the gas discharge chamber 150, using a beam splitter. Additionally, the line center analysis sub-unit 641 can include a broad band photodetector that can serve to detect the presence of a high enough intensity of broadband light to indicate the timing of the discharge in the gain medium within the gas discharge chamber 150. The line center analysis sub-unit 641 is configured to output a value or set of values that indicates the determined performance parameters.

The spectral feature sub-unit 642 observes, measures, or estimates one or more spectral features (such as wavelength and bandwidth) of one or more amplified light beams such as light beams 153, 165 produced by or within the gas discharge stage 155. For example, the spectral feature sub-unit 642 can include one or more optical elements arranged in the path of the light beam (or a separated-out portion of the light beam) to analyze these spectral features of the light beam. The optical elements can form a spectroscopic device and include such elements as an interferometer, a diffractive grating, a reference light source, a reference bandwidth source, a resonator, and/or an etalon. The spectral feature sub-unit 642 is configured to output a value or set of values that indicate these determined spectral features.

The actuator sub-unit 643 can be configured to observe, estimate, or measure other operating characteristics of actuators associated with operating the gas discharge stage 155. For example, the actuator sub-unit 643 can be configured to observe an energy supplied to the gas discharge chamber 150 from the energy source 152, or a voltage supplied to the energy source 152. The actuator sub-unit 643 can be within a beam imaging/analysis module that is configured to sample the light beam 153 or 165 to capture both near field and far field profiles of the light beam 153 or 165 in a single camera image. Such beam imaging/analysis module includes an autoshutter and additional metrology used to monitor light beam performance in situ. The beam imaging/analysis module receives an input beam that is split from the light beam 153 or 165 by a beamsplitter. The autoshutter is arranged and configured to block the unsplit portion of the light beam 153 or 165 when closed and to allow the light beam to exit without interference when opened. The additional metrology is arranged to receive the split portion of the light beam 153 or 165 and can include various photodetectors and position detectors. It also can include an optical system and an image sensor such as a two-dimensional camera, which captures images of the light beam, which can be near field and far field two-dimensional images of the light beam but can also include intermediate images. Thus, one output of the beam imaging/analysis module is a two-dimensional (2D) cross section of the intensity of the light beam profile. This 2D cross section can be used to measure the light beam profile and to detect distortions or irregularities. The data can be used to derive useful information on beam polarization, profile, divergence, and pointing for immediate observation as well as for longer term storage and retrieval. The energy variation predictor dE/dV can be inferred from readings from a submodule within the beam imaging/analysis module.

Referring to FIG. 7, an implementation 705 of the control system 105 is shown. The control system 705 includes the performance monitoring module 115, which is in communication with the monitoring system 140 as well as the gas recovery module 110. The control system 705 also includes the gas recovery module 110, which is in communication with the monitoring system 140 and the gas supply system 170.

The control system 705 can further include a light source module 706 configured to operate the light source 160 to produce the light beam 165. The light source module 706 can therefore include a sub-module in communication with the monitoring system 140, a sub-module in communication with the gas supply system 170, a sub-module in communication with components (such as optical and electrical actuators) within the light source 160.

The control system 705 can also include a status module 707 configured to determine whether the gas discharge chamber 150 is in a refill mode or a standard mode of operation. The status module 707 can receive information from the gas discharge stage 155 and/or the gas supply system 170 that indicates whether or not a refill of the gas mixture 151 is presently occurring or has recently completed. For example, in some implementations, the status module 707 receives a status of one or more fluid control valves within the gas supply system 170. The fluid control valves are configured to open to thereby supply gas to the gas discharge chamber 150 during a refill event and to close at other times. If one or more of the fluid control valves are open, then this can indicate that the gas discharge chamber 150 is in a refill state. In some implementations, the status module 707 can access a “gas status” variable that is produced or set by the gas discharge stage 155, the gas discharge chamber 150, or the gas supply system 170. The gas status of the gas discharge chamber 150 can indicate, for example that a refill has been requested and/or is being performed, that a gas recovery scheme is being performed, or that the gas discharge chamber 150 is operating in a standard mode of operation.

The control system 705 also includes a refill module 713 configured to control the refill of the gas mixture 151 within the gas discharge chamber 150. For example, the refill module 713 can communicate with the gas supply system 170, 470 to control the refill. The refill module 713 can instruct the gas supply system 170, 470 to empty the gas discharge chamber 150 by bleeding the gas mixture 151 by way of the valve system 472 to the gas dump 473, and then instruct the gas supply system 170, 470 to refill the gas discharge chamber 150 with a fresh or new gas mixture. The refill module 713 can send one or more signals to the valve system 472 to cause the valve system 472 to transfer gases from one or more specific gas sources 471A, 471B, 471C into the gas discharge chamber 150 during the gas refill.

The control system 705 includes memory 708 that is accessible to one or more of the modules within the control system 705. The memory 708 is configured to store information output from each of these modules or information received from the monitoring system 140 for various use by other modules during operation of the control system 705. The memory 708 can be read-only memory and/or random-access memory and can provide a storage device suitable for tangibly embodying computer program instructions and data.

The control system 705 also includes one or more input and/or output devices 709 (such as a keyboard, touch-enabled devices, audio input devices as input and audio or video for output), and one or more processors 710. The control system 705 can include other modules not described.

Communication between any of the modules 110, 115, 706, 707, 713 and the memory 708 can be by a direct or physical connection (for example, wired) or by a wireless connection so that information can be freely passed between the modules of the control system 705, the memory 708, and the other components of the gas control apparatus 100.

Although the control system 705 is represented as a box in which all of the components appear to be co-located, it is possible for the control system 705 to be made up of components (such as the modules 110, 115, 706, 707, 713) that are physically remote from each other. Each of the modules 110, 115, 706, 707, 713 can be a dedicated processing system for receiving data and analyzing data, or one or more of the modules 110, 115, 706, 707, 713 can be combined into a single processing system. Each of the modules 110, 115, 706, 707, 713 can include or have access to one or more programmable processors 710 and can each execute a program of instructions to perform desired functions by operating on input data and generating appropriate output. The modules 110, 115, 706, 707, 713 can be implemented in any of digital electronic circuitry, computer hardware, firmware, or software.

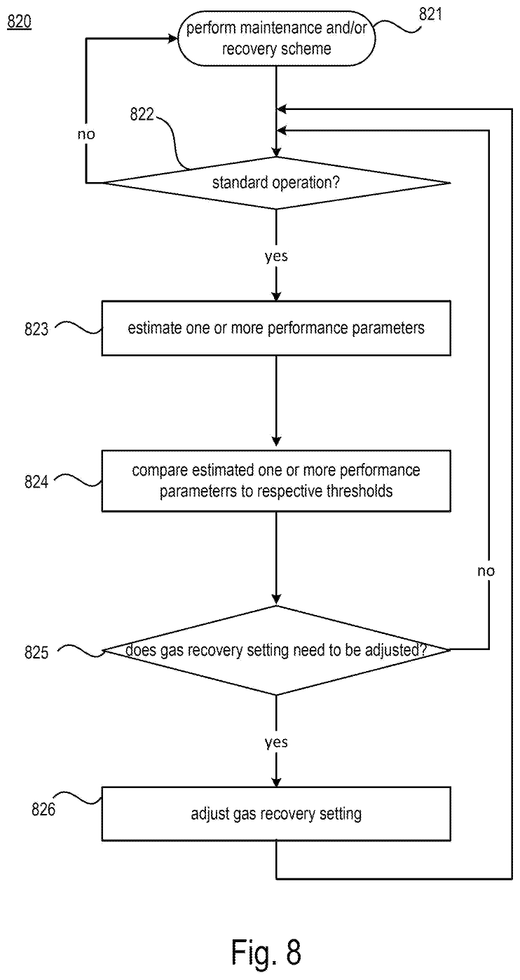

Referring to FIG. 8, a procedure 820 is performed by the control system 105 for controlling the gas mixture 151 of the gas discharge chamber 150. The procedure 820 begins with the performance of a gas maintenance scheme (such as a refill) and/or gas recovery scheme (821) that is performed on the gas discharge chamber 150. For example, at step 821, the gas recovery module 110 can perform a gas recovery scheme after a gas refill has been completed. The procedure 820 includes determining whether the gas discharge chamber 150 should now operate in standard mode of operation (822). In particular, the control system 105 can determine that the gas recovery scheme is completed and thus the gas discharge chamber 150 can operate in standard mode of operation.

If the gas recovery module 110 has completed the gas recovery scheme (822), the gas discharge chamber 150 enters standard mode of operation, and the control system 105 estimates one or more performance parameters (823) during the standard mode of operation of the gas discharge chamber 150. In particular, the performance monitoring module 115 can receive the data from the monitoring system 140, and estimate the performance parameters (823). The monitoring system 140 monitors one or more aspects of the light source 160, including the amplified light beams 153, 165, the energy storage actuator 154, and the gas supply system 170 at regular intervals during standard operation of the light source 160.

The control system 105 compares the estimated performance parameters to their respective thresholds (824). For example, once the performance parameters are estimated (823), then the performance monitoring module 115 can access the respective thresholds that are stored within memory 708, and compare each performance parameter to its respective threshold. In one comparison, the performance monitoring module 115 determines whether each performance parameter is greater than its respective threshold. In other comparisons, the performance monitoring module 115 can determine whether each performance parameter is less than its respective threshold. And, in still other comparisons, the performance monitoring module 115 can determine whether one or more of the performance parameters are greater than their respective thresholds and whether one or more of the performance parameters are less than their respective thresholds.

The control system 105 determines whether the gas recovery setting needs to be adjusted based on the comparison at 824 (825). For example, in some implementations, the performance monitoring module 115 determines that the gas recovery setting needs to be adjusted if one (and only one) of the performance parameters is not greater than its threshold. In other implementations, the performance monitoring module 115 can determine that the gas recovery setting needs to be adjusted if all of the performance parameters are not greater than their respective thresholds. Next, if it is determined that the gas recovery setting needs to be adjusted at 825, then the control system 105 adjusts the gas recovery setting (826). For example, the performance monitoring module 115 can incrementally change the value of the gas recovery setting either up or down and within a range of acceptable values and then save the new value of the gas recovery setting within memory 708 so that the gas recovery module 110 can access the gas recovery setting when the next gas recovery scheme is performed (821).

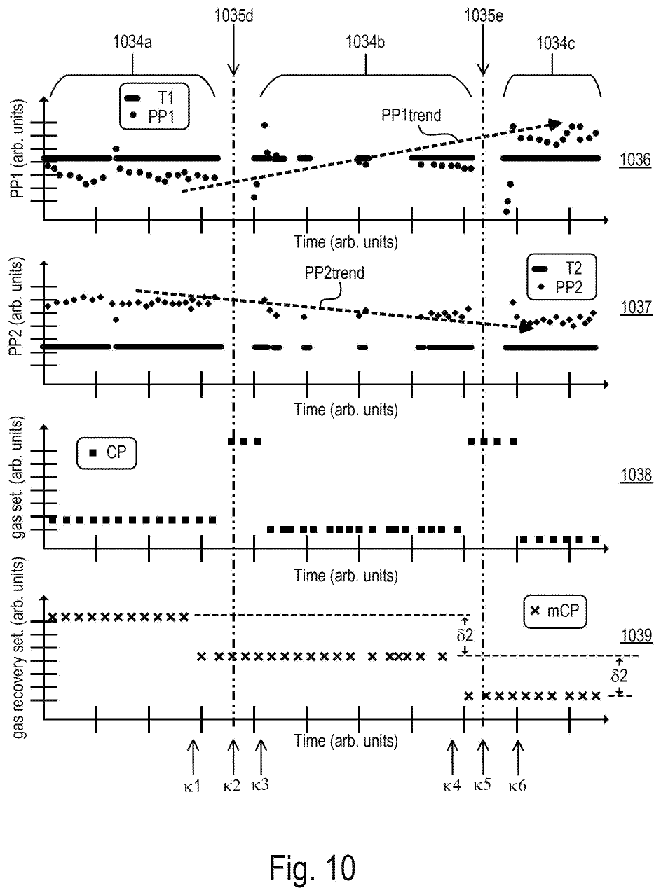

The steps 823, 824, 825, 826 (referred to as the performance monitoring steps) in the procedure 820 are performed by the performance monitoring module 115 iteratively, or at periodic intervals, such as once every certain number of seconds or number of minutes during standard mode of operation of the gas discharge chamber 150. In one implementation, the performance monitoring steps are performed every two hours during standard operation. The value of the gas recovery setting (such as mCP shown in FIG. 10) could be updated many times during standard operation. It is the current value of mCP that is accessed from memory 708 by the gas recovery module 110 when the next gas recovery scheme is performed. The procedure 820 can further include, after the adjustment is effected 826, exiting the performance monitoring steps 823, 824, 825, 826 (and halting further adjustment of the gas recovery setting) when a command is received indicating a start of a gas refill and/or a gas recovery scheme 821 (822). Moreover, the gas recovery module 110 effects and causes the gas supply system 170 to perform the gas recovery scheme after the gas supply system 170 has completed the gas refill (under control of the refill module 713).

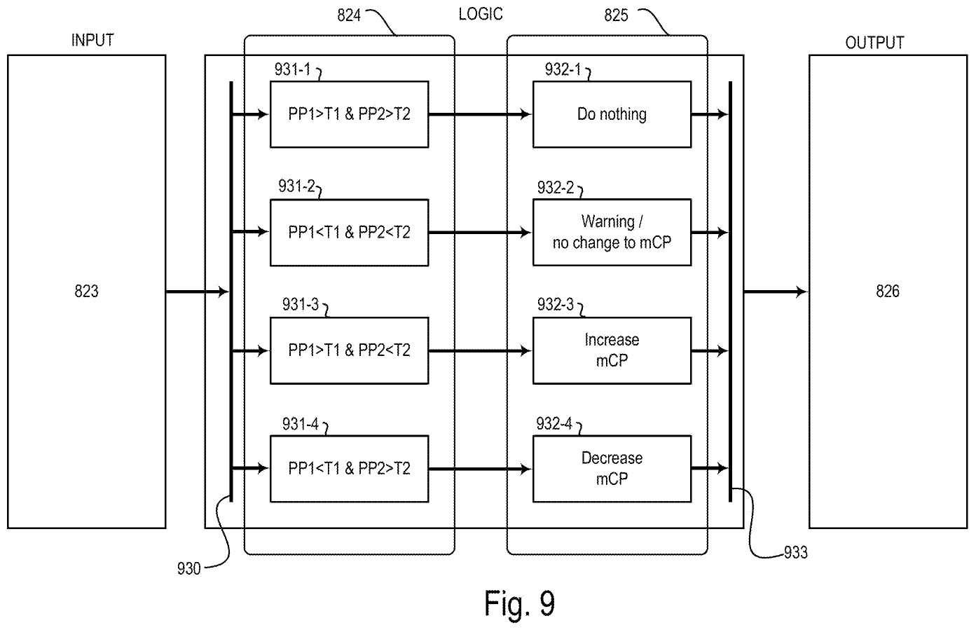

FIG. 9 shows an example in which the estimated performance parameters are the energy E150 (PP1) and the energy variation predictor dE/dV (PP2), and the gas recovery setting is the minimum limit of the pressure within the gas discharge chamber 150 (the minChamberPres or mCP). At step 823, the performance monitoring module 115 has estimated the performance parameters PP1 (E150) and PP2 (dE/dV), and these are forwarded 930 to step 824 for further analysis. As discussed above, at step 824, the performance monitoring module 115 compares the estimated performance parameters to their respective thresholds. In this example, the value of E150 (PP1) is compared to its threshold T1 and the value of dE/dV (PP2) is compared to its threshold T2. Then, at step 825, the performance monitoring module 115 determines whether the gas recovery setting mCP needs to be adjusted and forwards 935 this decision to the next step 826, as discussed above.

Four possible comparison states 931-1, 931-2, 931-3, 931-4 are possible as follows. In the first comparison state 931-1, E150 is greater than its threshold T1 and dE/dV is greater than its threshold T2. If the performance monitoring module 115 determines that the state 931-1 is true at 824, then it determines that the gas recovery setting mCP does not need to be adjusted 932-1 at 825.

In the second comparison state 931-2, E150 is not greater than its threshold T1 and dE/dV is not greater than its threshold T2. If the performance monitoring module 115 determines that the state 931-2 is true at 824, then it determines that the gas recovery setting mCP does not need to be adjusted 932-2 and also determines that a warning should be issued at 825. A warning indicates that one or more remedies may be needed by other components of the control system 105 during standard operation to address the poorly performing aspects of the light source 160 (as indicated by the fact that both of the performance parameters are not at acceptable levels).

In the third comparison state 931-3, E150 is greater than its threshold T1 and dE/dV is not greater than its threshold T2. If the performance monitoring module 115 determines that the state 931-3 is true at 824, then it determines that the gas recovery setting mCP needs to be adjusted 932-3 by incrementally increasing its value at 825. For example, the minimum pressure within the gas discharge chamber 150 (or within one or more of the gas discharge chambers within the light source 160), referred to as minChamberPres can be increased by an increment of 5 kiloPascals (kpa) if such an increase will maintain the value within an acceptable range of values between a maximum and a minimum. In other implementations, the incremental increase can be 10 kpa, 15, kpa, or 20 kpa. In further implementations, the incremental increase can be configurable and modifiable to any suitable value. As discussed above with reference to FIGS. 2A and 2B, in this particular state 931-3, dE/dV is too low, even though E150 is within an acceptable range of values. Thus, the minChamberPres needs to be increased until dE/dV is also within an acceptable range of values (and the state returns to 931-1).

In the fourth comparison state 931-4, E150 is not greater than its threshold T1 and dE/dV is greater than its threshold T2. If the performance monitoring module 115 determines that the state 931-4 is true at 824, then it determines that the gas recovery setting mCP needs to be adjusted 932-4 by incrementally decreasing its value at 825. For example, the minimum pressure within the gas discharge chamber 150 (or within one or more of the gas discharge chambers within the light source 160), referred to as minChamberPres, can be decreased by the increment of 5 kiloPascals (kpa) if such a decrease will maintain minChamberPres within an acceptable range of values between a maximum and a minimum. In other implementations, the incremental decrease can be 10 kpa, 15, kpa, or 20 kpa. In further implementations, the incremental decrease can be configurable and modifiable to any suitable value. As discussed above with reference to FIGS. 2A and 2B, in this particular state 931-4, E150 is too low, even though dE/dV is within an acceptable range of values. Thus, the minChamberPres needs to be decreased until E150 is also within an acceptable range of values (and the state returns to 931-1).

FIG. 10 shows a set of graphs 1036, 1037, 1038, 1039 for the example discussed with reference to FIG. 9, in which the performance parameter PP1 is E150, the performance parameter PP2 is dE/dV, and the gas recovery setting is minChamberPres. Graph 1036 shows E150 (PPT) and the threshold value (T1) of E150 versus time during three distinct standard operations 1034a, 1034b, 1034c of the gas discharge chamber 150; graph 1037 shows dE/dV (PP2) and the threshold value (T2) of dE/dV versus time during the same distinct standard operations 1034a, 1034b, 1034c of the gas discharge chamber 150; graph 1038 shows the pressure CP within the gas discharge chamber 150 during the same distinct standard operations 1034a, 1034b, 1034c; and graph 1039 shows the gas recovery setting minChamberPres for the gas discharge chamber 150 during the same distinct standard operations 1034a, 1034b, 1034c. In the window of time shown in these graphs, the standard operation 1034a is followed by a refill 1035d and the standard operation 1034b is followed by a refill 1035e. The values of the performance parameters E150 and dE/dV are not tracked for this purpose during refill or during the gas recovery scheme that follows each refill. The vertical scales for each graph can be different.

During standard operation 1034a, and until time κ1, as shown in graph 1036, E150 (PP1) is generally operating below its threshold T1, while dE/dV (PP2) is operating above its threshold T2. Moreover, the pressure CP within the gas discharge chamber 150 is at 255 kpa, which is close to the current value of the gas recovery setting mCP. The performance monitoring module 115 determines that the light source 160 is operating in the fourth comparison state 931-4. Thus, at time κ1, the performance monitoring module 115 reduces the value of mCP by an increment δ1 (the fourth adjustment 932-4). For example, the value of mCP can be reduced from 255 kpa to 250 kpa and thus the increment δ1 is 5 kpa. A refill 1035d is performed at time κ2. And, during the gas recovery scheme (between time κ2 and time κ3), the pressure CP within the gas discharge chamber 150 is successfully decreased to the pressure limit (mCP). Moreover, E150 has improved following time κ3, but it is still below its threshold T1 during standard operation 1034b and thus the light source 160 is still operating in the fourth comparison state 931-4. Accordingly, at time κ4, the performance monitoring module 115 reduces the value of mCP by an increment 62 (the fourth adjustment 932-4). For example, the value of mCP can be reduced from 250 kpa to 245 kpa and thus the increment 62 is 5 kpa. A second refill 1035e is performed at κ5. After the second refill 1035e, E150 has improved and is now greater than its threshold T1 and dE/dV is still above its threshold T2. During the gas recovery scheme (between time κ5 and time κ6), the pressure CP within the gas discharge chamber 150 is successfully decreased to closer to the pressure limit (mCP). Thus, the performance monitoring module 115 determines that the light source 160 is operating in the first comparison state 931-1 and no action needs to be taken to adjust the value of mCP (the first adjustment 932-1).

In practice, a refill such as the refills 1035d and 1035e shown in FIG. 10 occur every several days (or once a month), for example.

The implementations and/or embodiments can be further described using the following clauses:

1. A gas control apparatus associated with a gas discharge chamber within a light source, the gas control apparatus comprising:
a monitoring system configured to estimate one or more performance parameters of the gas discharge chamber; and
a control system in communication with the monitoring system and the gas discharge chamber, the control system configured to, during standard mode of operation of the gas discharge chamber and in between performance of gas recovery schemes on the gas discharge chamber that use a gas recovery setting:
compare the estimated one or more performance parameters to respective thresholds;
determine whether the gas recovery setting needs to be adjusted based on the comparison; and adjust the value for the gas recovery setting based on the determination.

2. The gas control apparatus of clause 1, further comprising a gas supply system configured to inject and/or remove one or more gas components of a gas mixture within the gas discharge chamber in accordance with at least one gas recovery setting and under control of the control system during the gas recovery scheme.

3. The gas control apparatus of clause 1, wherein the control system is configured to, during standard operation of the gas discharge chamber and in between performing gas recovery schemes on the gas discharge chamber that use the gas recovery setting, save the adjusted value for the gas recovery setting.

4. The gas control apparatus of clause 1, wherein the control system accesses the most recent adjusted value for the gas recovery setting when performing the next gas recovery scheme.

5. The gas control apparatus of clause 1, wherein the gas recovery setting is an extreme operating value of a gas characteristic.

6. The gas control apparatus of clause 1, wherein the gas recovery setting is an extreme value of a pressure in the gas discharge chamber.

7. The gas control apparatus of clause 1, wherein the monitoring system being configured to estimate one or more performance parameters of the gas discharge chamber comprises the monitoring system estimating one or more of: an energy of a light beam output from the gas discharge chamber, an energy variation predictor of an energy source actuator of the gas discharge chamber, a spectral feature of a light beam output from the gas discharge chamber, an energy supplied to the gas discharge chamber by way of the energy source actuator, and an arcing risk sensitivity.

8. The gas control apparatus of clause 1, wherein the control system being configured to adjust the value for the gas recovery setting based on the determination comprises adjusting the value for the gas recovery setting by an incremental amount and between a maximum and a minimum extreme value.

9. The gas control apparatus of clause 1, wherein the control system being configured to compare the estimated one or more performance parameters to respective thresholds comprises determining whether each performance parameter exceeds its respective threshold, wherein a performance parameter is at an acceptable value if it exceeds its respective threshold.

10. The gas control apparatus of clause 1, wherein, during standard operation of the gas discharge chamber and in between performing gas recovery schemes on the gas discharge chamber that use the gas recovery setting, the monitoring system estimates the one or more performance parameters of the gas discharge chamber at periodic intervals.

11. The gas control apparatus of clause 10, wherein the control system is configured to, for each time the one or more performance parameters are estimated by the monitoring system, compare the estimated one or more performance parameters are to respective thresholds, determine whether to adjust the gas recovery setting based on the comparison, and adjust the value for the gas recovery setting based on the determination.

12. The gas control apparatus of clause 1, wherein the control system is further configured to halt adjusting the value for the gas recovery setting when a command is received indicating a start of the gas recovery scheme.

13. The gas control apparatus of clause 1, wherein the control system is configured to perform a gas recovery scheme after directing a gas refill on the gas discharge chamber.

14. The gas control apparatus of clause 1, wherein the monitoring system is configured to monitor at least one gas discharge chamber of a two-stage light source that includes a master oscillator gas discharge chamber and a power amplifier gas discharge chamber.

15. The gas control apparatus of clause 14, wherein the control system is in communication with the master oscillator gas discharge chamber and the power amplifier gas discharge chamber, and the gas recovery setting relates to the power amplifier gas discharge chamber.

16. The gas control apparatus of clause 1, wherein the gas discharge chamber is implemented in a gas discharge stage of the light source, the gas discharge stage producing an amplified light beam from a population inversion occurring in a gas mixture within the gas discharge chamber when energy is provided to the gas mixture.

17. The gas control apparatus of clause 1, wherein the monitoring system being configured to estimate the one or more performance parameters of the gas discharge chamber comprises the monitoring system measuring one or more aspects relating to performance of the gas discharge chamber and analyzing the measured aspects.

18. A method for controlling a gas mixture of a gas discharge chamber within a gas discharge light source, the method comprising:
during standard operation of the gas discharge chamber and in between performing gas recovery schemes on the gas discharge chamber that use a gas recovery setting:
estimating one or more performance parameters of the gas discharge chamber;
comparing the estimated one or more performance parameters to respective thresholds;
determining whether the gas recovery setting needs to be adjusted based on the comparison; and adjusting the value for the gas recovery setting based on the determination.

19. The method of clause 18, further comprising, during standard operation of the gas discharge chamber and in between performing gas recovery schemes on the gas discharge chamber that use a gas recovery setting, saving the adjusted value for the gas recovery setting.

20. The method of clause 18, further comprising providing the most recent adjusted value for the gas recovery setting to the next gas recovery scheme.

21. The method of clause 18, wherein the gas recovery setting is an extreme operating value of a gas characteristic.

22. The method of clause 18, wherein the gas recovery setting is an extreme value of a pressure in the gas discharge chamber.

23. The method of clause 18, wherein estimating one or more performance parameters of the gas discharge chamber comprises estimating one or more of: an energy of a light beam output from the gas discharge chamber, an energy variation predictor of an energy source actuator of the gas discharge chamber, a spectral feature of a light beam output from the gas discharge chamber, an energy supplied to the gas discharge chamber by way of the energy source actuator, and an arcing risk sensitivity.

24. The method of clause 18, wherein determining whether the gas recovery setting needs to be adjusted based on the comparison comprises determining that the gas recovery setting does not need to be adjusted if all of the estimated one or more performance parameters exceed their respective thresholds.

25. The method of clause 24, wherein a performance parameter exceeds its threshold if it is greater than its threshold.

26. The method of clause 24, wherein determining whether the gas recovery setting needs to be adjusted based on the comparison comprises determining that the gas recovery setting needs to be adjusted if one of the estimated one or more performance parameters does not exceed its respective threshold and the remaining of the estimated one or more performance parameters exceed their respective thresholds.

27. The method of clause 24, wherein determining whether the gas recovery setting needs to be adjusted based on the comparison comprises determining that the gas recovery setting does not need to be adjusted if all of the estimated one or more performance parameters do not exceed their respective thresholds.

28. The method of clause 18, wherein adjusting the value for the gas recovery setting based on the determination comprises adjusting the value for the gas recovery setting by an incremental amount and between a maximum and a minimum extreme value.

29. The method of clause 18, wherein comparing the estimated one or more performance parameters to respective thresholds comprises determining whether each performance parameter exceeds its respective threshold, wherein a performance parameter is at an acceptable value if it exceeds its respective threshold.

30. The method of clause 18, wherein, during standard operation of the gas discharge chamber and in between performing gas recovery schemes on the gas discharge chamber that use the gas recovery setting, the one or more performance parameters of the gas discharge chamber are estimated at periodic intervals.

31. The method of clause 30, further comprising, each time the one or more performance parameters are estimated, then the estimated one or more performance parameters are compared to respective thresholds, whether to adjust the gas recovery setting is determined based on the comparison, and the value for the gas recovery setting is adjusted based on the determination.

32. The method of clause 18, further comprising halting adjusting the value for the gas recovery setting when a command is received indicating a start of the gas recovery scheme.

33. The method of clause 18, further comprising performing a gas recovery scheme on the gas discharge chamber after a gas refill on the gas discharge chamber is performed.

34. The method of clause 18, wherein estimating the one or more performance parameters of the gas discharge chamber comprises measuring one or more aspects relating to performance of the gas discharge chamber and analyzing the measured aspects.

35. A gas control apparatus associated with a gas discharge chamber, the gas control apparatus comprising a control system in communication with the gas discharge chamber, the control system comprising:
a performance monitoring module configured to, during standard mode of operation of the gas discharge chamber and in between performance of gas recovery schemes on the gas discharge chamber that use a gas recovery setting:
compare one or more performance parameters of the gas discharge chamber to respective thresholds;
determine whether the gas recovery setting needs to be adjusted based on the comparison; and
adjust the value for the gas recovery setting based on the determination; and
a gas recovery module configured to perform the gas recovery scheme, the gas recovery module being configured to access the most recently adjusted value for the gas recovery setting from the performance monitoring module when performing the current gas recovery scheme.

Other implementations are within the scope of the following claims.

1. A gas control apparatus associated with a gas discharge chamber within a light source, the gas control apparatus comprising:
a monitoring system configured to estimate one or more performance parameters of the gas discharge chamber; and
a control system in communication with the monitoring system and the gas discharge chamber, the control system configured to, during standard mode of operation of the gas discharge chamber and in between performance of gas recovery schemes on the gas discharge chamber that use a gas recovery setting:
compare the estimated one or more performance parameters to respective thresholds;
determine whether the gas recovery setting needs to be adjusted based on the comparison; and
adjust the value for the gas recovery setting based on the determination.

2. The gas control apparatus of claim 1, further comprising a gas supply system configured to inject and/or remove one or more gas components of a gas mixture within the gas discharge chamber in accordance with at least one gas recovery setting and under control of the control system during the gas recovery scheme.

3. The gas control apparatus of claim 1, wherein the control system is configured to, during standard operation of the gas discharge chamber and in between performing gas recovery schemes on the gas discharge chamber that use the gas recovery setting, save the adjusted value for the gas recovery setting.

4. The gas control apparatus of claim 1, wherein the control system accesses the most recent adjusted value for the gas recovery setting when performing the next gas recovery scheme.

5. (canceled)

6. (canceled)

7. The gas control apparatus of claim 1, wherein the monitoring system being configured to estimate one or more performance parameters of the gas discharge chamber comprises the monitoring system estimating one or more of: an energy of a light beam output from the gas discharge chamber, an energy variation predictor of an energy source actuator of the gas discharge chamber, a spectral feature of a light beam output from the gas discharge chamber, an energy supplied to the gas discharge chamber by way of the energy source actuator, and an arcing risk sensitivity.

8. (canceled)

9. (canceled)

10. The gas control apparatus of claim 1, wherein, during standard operation of the gas discharge chamber and in between performing gas recovery schemes on the gas discharge chamber that use the gas recovery setting, the monitoring system estimates the one or more performance parameters of the gas discharge chamber at periodic intervals.

11. (canceled)

12. (canceled)

13. The gas control apparatus of claim 1, wherein the control system is configured to perform a gas recovery scheme after directing a gas refill on the gas discharge chamber.

14. The gas control apparatus of claim 1, wherein the monitoring system is configured to monitor at least one gas discharge chamber of a two-stage light source that includes a master oscillator gas discharge chamber and a power amplifier gas discharge chamber.

15. (canceled)

16. The gas control apparatus of claim 1, wherein the gas discharge chamber is implemented in a gas discharge stage of the light source, the gas discharge stage producing an amplified light beam from a population inversion occurring in a gas mixture within the gas discharge chamber when energy is provided to the gas mixture.

17. (canceled)

18. A method for controlling a gas mixture of a gas discharge chamber within a gas discharge light source, the method comprising:
during standard operation of the gas discharge chamber and in between performing gas recovery schemes on the gas discharge chamber that use a gas recovery setting:
estimating one or more performance parameters of the gas discharge chamber;
comparing the estimated one or more performance parameters to respective thresholds;
determining whether the gas recovery setting needs to be adjusted based on the comparison; and
adjusting the value for the gas recovery setting based on the determination.

19. The method of claim 18, further comprising, during standard operation of the gas discharge chamber and in between performing gas recovery schemes on the gas discharge chamber that use a gas recovery setting, saving the adjusted value for the gas recovery setting.

20. The method of claim 18, further comprising providing the most recent adjusted value for the gas recovery setting to the next gas recovery scheme.

21. (canceled)

22. (canceled)

23. The method of claim 18, wherein estimating one or more performance parameters of the gas discharge chamber comprises estimating one or more of: an energy of a light beam output from the gas discharge chamber, an energy variation predictor of an energy source actuator of the gas discharge chamber, a spectral feature of a light beam output from the gas discharge chamber, an energy supplied to the gas discharge chamber by way of the energy source actuator, and an arcing risk sensitivity.

24. The method of claim 18, wherein determining whether the gas recovery setting needs to be adjusted based on the comparison comprises determining that the gas recovery setting does not need to be adjusted if all of the estimated one or more performance parameters exceed their respective thresholds.

25-27. (canceled)

28. The method of claim 18, wherein adjusting the value for the gas recovery setting based on the determination comprises adjusting the value for the gas recovery setting by an incremental amount and between a maximum and a minimum extreme value.

29. (canceled)

30. The method of claim 18, wherein, during standard operation of the gas discharge chamber and in between performing gas recovery schemes on the gas discharge chamber that use the gas recovery setting, the one or more performance parameters of the gas discharge chamber are estimated at periodic intervals.

31. The method of claim 30, further comprising, each time the one or more performance parameters are estimated, then the estimated one or more performance parameters are compared to respective thresholds, whether to adjust the gas recovery setting is determined based on the comparison, and the value for the gas recovery setting is adjusted based on the determination.

32. (canceled)

33. The method of claim 18, further comprising performing a gas recovery scheme on the gas discharge chamber after a gas refill on the gas discharge chamber is performed.

34. The method of claim 18, wherein estimating the one or more performance parameters of the gas discharge chamber comprises measuring one or more aspects relating to performance of the gas discharge chamber and analyzing the measured aspects.

35. A gas control apparatus associated with a gas discharge chamber, the gas control apparatus comprising a control system in communication with the gas discharge chamber, the control system comprising:
a performance monitoring module configured to, during standard mode of operation of the gas discharge chamber and in between performance of gas recovery schemes on the gas discharge chamber that use a gas recovery setting:
compare one or more performance parameters of the gas discharge chamber to respective thresholds;
determine whether the gas recovery setting needs to be adjusted based on the comparison; and
adjust the value for the gas recovery setting based on the determination; and
a gas recovery module configured to perform the gas recovery scheme, the gas recovery module being configured to access the most recently adjusted value for the gas recovery setting from the performance monitoring module when performing the current gas recovery scheme.
